(19) United States
(12) Patent Application Publication
(10) Pub. No.: US 2006/0009101 A1
(43) Pub. Date: Jan. 12, 2006

(54) Cloth member to guard against mosquito

(76) Inventor: Su Jen Chou, Ho Mei Town (TW)

Correspondence Address: CHARLES E. BAXLEY, ESQ., 90 JOHN STREET, THIRD FLOOR, NEW YORK, NY, 10038, US

(21) Appl. No.: 10/887,257

(22) Filed: Jul. 7, 2004

(51) Int. Cl. B32B 27/04

(52) U.S. Cl. 442/59; 442/123

(57) ABSTRACT

A cloth member includes a base layer, and a cover layer secured onto the base layer by such as stitches. The cover layer is treated with an anti-mosquito solution, or includes an anti-mosquito solution engaged in the inner portion, to guard against mosquitoes, and to prevent mosquitoes from flying close to the cover layer. The cover layer includes a number of hair members disposed on top, to form a hairy structure, and to prevent the mosquito from biting through the hairy cover layer.

### BACKGROUND OF THE INVENTION

1. Field of the Invention

The present invention relates to a cloth member, and more particularly to an anti-mosquito cloth member to guard against or to repel mosquitoes, and to prevent users from being bitten by mosquitoes.

2. Description of the Prior Art

Typical cloth members comprise one or more woven or non-woven fibers or layers secured together, for making hats, clothes, sockets, gloves, etc., or other cloth articles. Normally, the typical cloth members are simply provided for making the cloth articles only, and may not be used to absorb odors, or may not be used to guard against or to repel mosquitoes, and also may not be used to prevent users from being bitten by mosquitoes.

U.S. Pat. No. 5,678,247 to Vickers discloses one of the typical cloth members including an odor absorbent layer engaged therein, to absorb odors. The odor absorbent layer comprises a sheet of non-woven synthetic fibers impregnated with powdered activated charcoal using a binder which provide a satisfactory degree of pliability to the resulting sheet layer and yet aptly bonds the carbon particles within the sheet of fibers.

However, the typical cloth members simply includes the odor absorbent layer engaged therein, to absorb odors, but may not be used to guard against or to repel mosquitoes, and also may not be used to prevent users from being bitten by mosquitoes.

The present invention has arisen to mitigate and/or obviate the afore-described disadvantages of the conventional cloth members.

### SUMMARY OF THE INVENTION

The primary objective of the present invention is to provide an anti-mosquito cloth member for guarding against or for repelling mosquitoes, and for preventing users from being bitten by mosquitoes.

In accordance with one aspect of the invention, there is provided a cloth member comprising a base layer, and a cover layer secured onto the base layer by such as stitches or the like. The cover layer has been treated with or dipped with an anti-mosquito solution, or may include the anti-mosquito solution engaged therein, to guard against mosquitoes, and to prevent mosquitoes from flying close to the cover layer, and the cover layer includes a plurality of hair members provided on top thereof, to form a hairy structure, and to prevent the mosquito from biting through the hairy cover layer, and thus to prevent the users from being bitten by mosquitoes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an anti-mosquito cloth member in accordance with the present invention;

FIG. 2 is an exploded view of the anti-mosquito cloth member;

FIG. 3 is an enlarged partial perspective view illustrating a base fabric layer of the anti-mosquito cloth member;

FIG. 4 is an enlarged partial perspective view illustrating an anti-mosquito layer of the anti-mosquito cloth member;

FIG. 5 is an enlarged partial perspective view illustrating a stitching or coupling operation for coupling the base fabric layer and the anti-mosquito layer of the anti-mosquito cloth member together;

FIG. 6 is a front view illustrating an attachment of the anti-mosquito cloth member to a user;

FIG. 7 is a front view similar to FIG. 6, illustrating the operation of the anti-mosquito cloth member; and

FIGS. 8, 9, 10, 11 are perspective views illustrating the articles to be made with the anti-mosquito cloth member.

### DETAILED DESCRIPTION OF THE PREFERRED EMBODIMENT

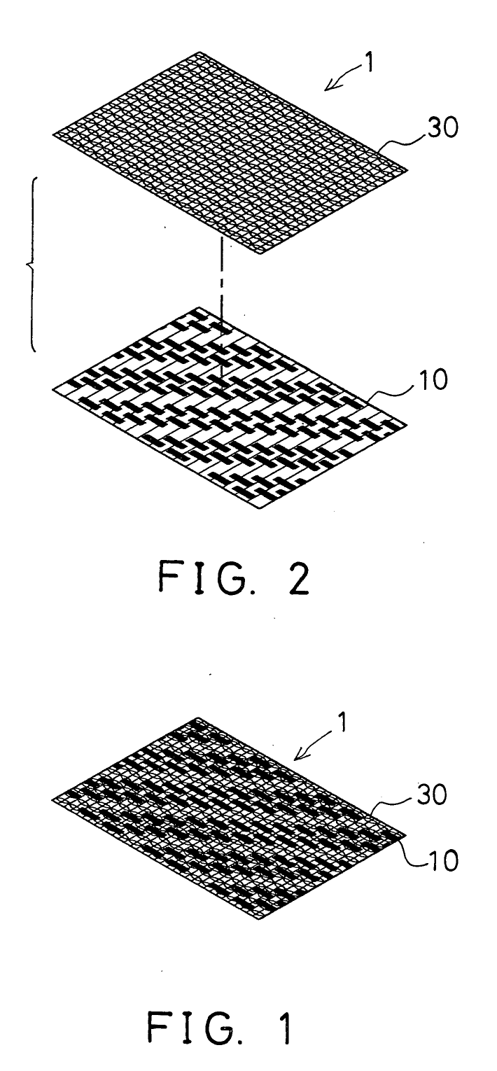

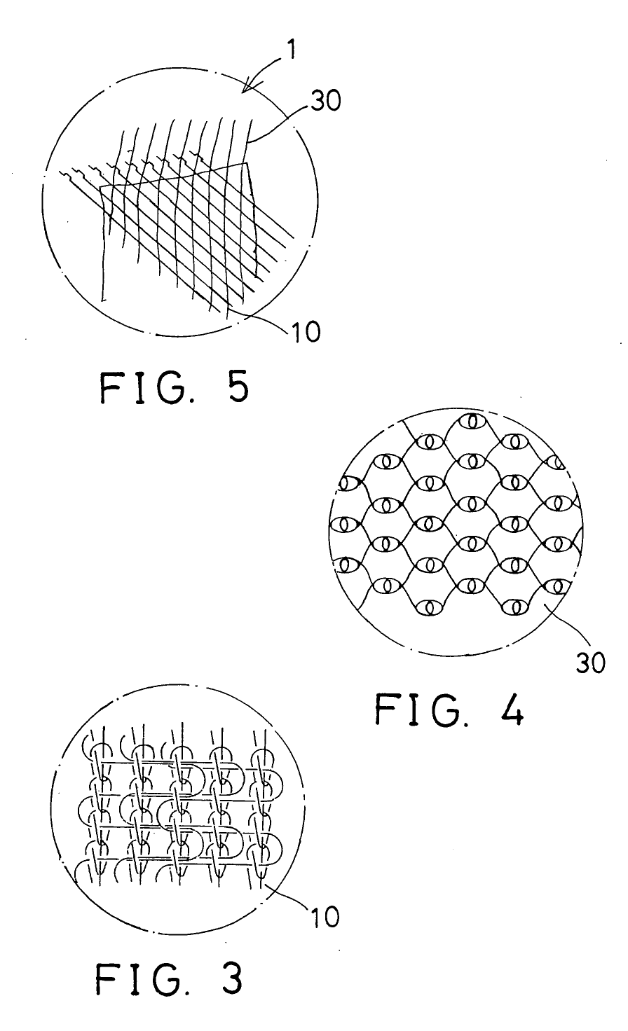

Referring to the drawings, and initially to FIGS. 1-6, an anti-mosquito cloth member 1 in accordance with the present invention comprises a base layer 10, such as a base cloth or fabric layer 10, which may be formed or made by woven or non-woven fibers or layers, or which may be formed by warp knitting or stitching operations.

The cloth member 1 further includes a cover layer 30 or an anti-mosquito cover layer 30 which may also be formed or made by woven or non-woven fibers or layers, or which may also be formed by warp knitting or stitching operations. The cover layer 30 is treated with or has been dipped in anti-mosquito solutions, or has anti-mosquito solutions engaged therein, to guard against or to repel mosquitoes, and to prevent mosquitoes from flying close to the anti-mosquito cover layer 30.

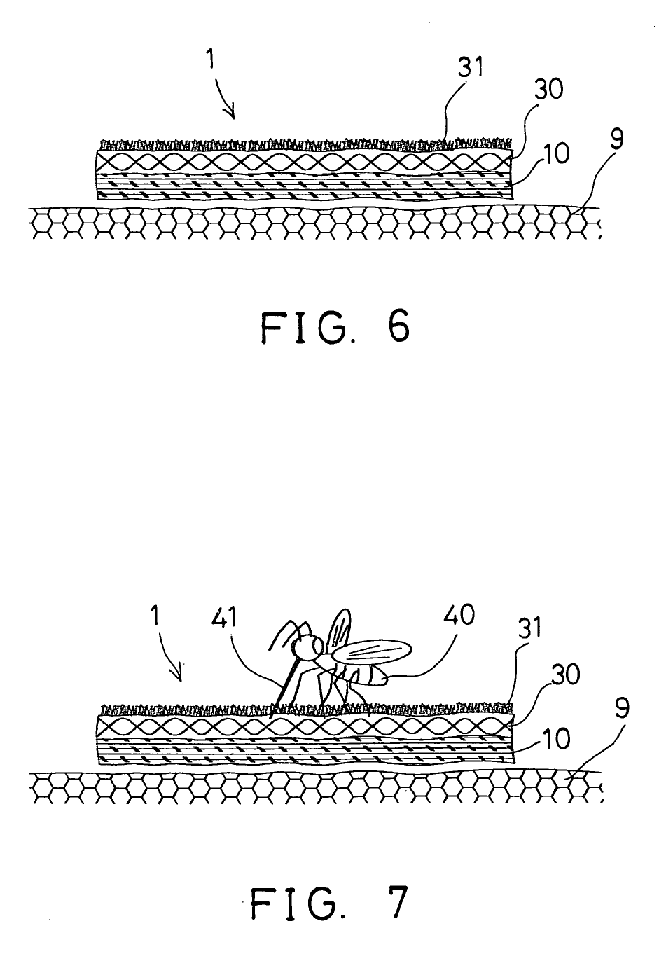

The anti-mosquito cover layer 30 and the base layer 10 are then secured together by such as stitching operations (FIG. 5), to solidly secure the anti-mosquito cover layer 30 and the base layer 10 together. The base layer 10 is provided for engaging onto the users 9 (FIGS. 6, 7), and preferably for allowing the users 9 to feel comfortable, and to prevent the anti-mosquito cover layer 30 from directly contacting with the users. The base layer 10 may also be provided for absorbing sweat or odors from the users 9, for example.

As shown in FIGS. 6 and 7, the cover layer 30 further includes a number of fine hair members 31 formed or provided thereon, such as provided on top thereof, to form a hairy structure, and to prevent the needle mouth 41 of the mosquito 40 from engaging into or biting into or through the hairy cover layer 30.

In operation, as shown in FIG. 7, in addition to the fine hair members 31 of the hairy cover layer 30, the anti-mosquito cover layer 30 that have been treated with or dipped with anti-mosquito solutions may further be used to guard against or to repel mosquitoes, and to prevent mosquitoes from flying close to the anti-mosquito cover layer 30, and thus to prevent the users from being bitten by mosquitoes.

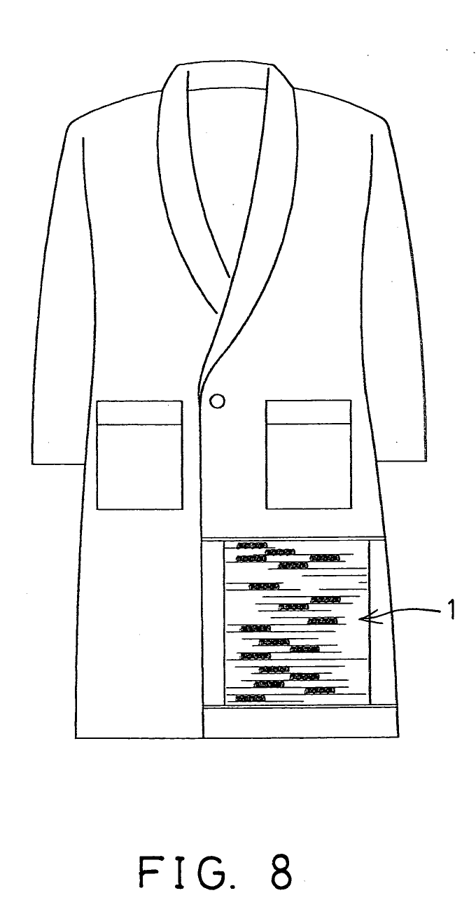

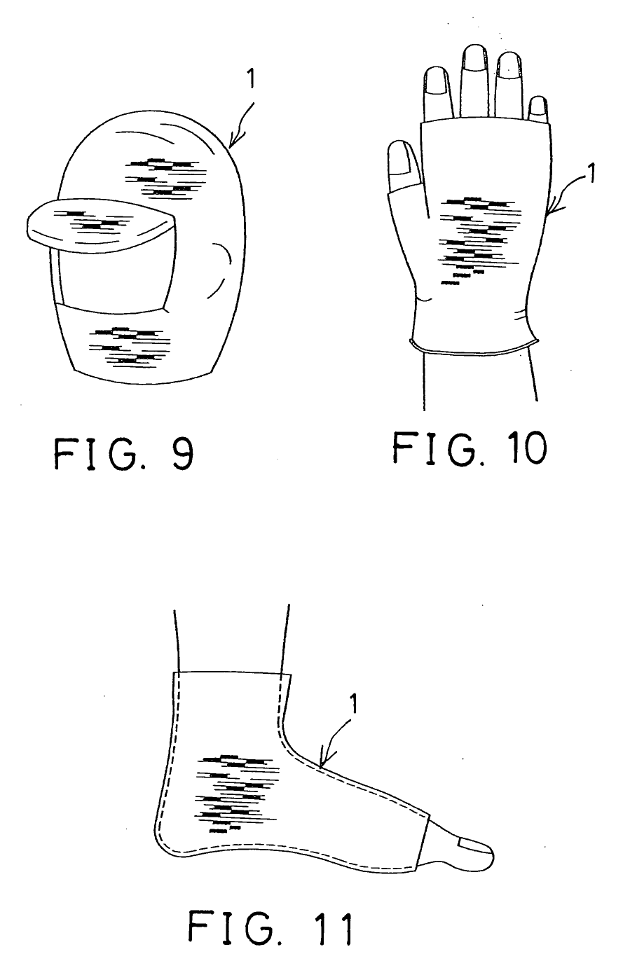

As shown in FIGS. 8-11, the cloth member 1 may be used for making various articles, such as clothes (FIG. 8), hats (FIG. 9), gloves (FIG. 10), sockets (FIG. 11), etc., or other cloth articles.

Accordingly, the anti-mosquito cloth member in accordance with the present invention may be used for guarding against or for repelling mosquitoes, and for preventing users from being bitten by mosquitoes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A cloth member comprising:
a base layer, and
a cover layer secured onto said base layer, and including an anti-mosquito solution engaged therein, to guard against mosquitoes, and to prevent mosquitoes from flying close to said cover layer, and said cover layer including a plurality of hair members provided on top thereof, to form a hairy structure, and to prevent the mosquito from biting through said hairy cover layer.
